(19) United States
(12) Patent Application Publication
(10) Pub. No.: US 2005/0159122 A1
(43) Pub. Date: Jul. 21, 2005

(54) Radio with simultaneous buffering of multiple stations

(76) Inventor: Robert S. Mayer, Scarsdale, NY (US)

Correspondence Address: Robert S. Mayer, 37 Harvard Road, Scarsdale, NY, 10583-6707, US

(21) Appl. No.: 11/039,582

(22) Filed: Jan. 18, 2005

Related U.S. Application Data
(60) Provisional application No. 60/537,767, filed on Jan. 20, 2004.

(51) Int. Cl. H04H 1/00; H04H 7/00; H04B 1/18

(52) U.S. Cl. 455/179.1; 455/188.1; 455/170.1; 455/3.01

(57) ABSTRACT

A number of radio programs are received simultaneously, and data representing the most recent interval of those programs is maintained in the memory. A user interface is provided with controls for switching programs, and a control for initiating playback of a delayed version of the currently selected program based on the data maintained in the memory. This arrangement permits the user to “rewind” a segment of whatever program the user is currently listening to, even immediately after switching stations.

### CROSS REFERENCE TO RELATED APPLICATIONS

This application claims priority to U.S. provisional application 60/537,767, filed Jan. 20, 2004, which is incorporated herein by reference. This application hereby references U.S. disclosure document 544,378.

### INTRODUCTION

Imagine that you're driving down the highway listening to your car radio, and you switch stations. The new station happens to be playing one of your favorite songs, but it's just about over. Wouldn't it be nice if your radio could “rewind” the broadcast so you could hear the song from the beginning?

### SUMMARY OF THE INVENTION

A number of radio programs are received simultaneously, and data representing the most recent interval of those programs is maintained in the memory. A user interface is provided with controls for switching programs, and a control for initiating playback of a delayed version of the currently selected program based on the data maintained in the memory.

### BRIEF DESCRIPTION OF THE DRAWINGS

FIG. 1 is a block diagram of an embodiment of the invention for use as a car radio.

FIG. 2A is a block diagram of a first digitizer that is suited for use in the FIG. 1 embodiment.

FIG. 2B is a block diagram of a second digitizer that is suited for use in the FIG. 1 embodiment.

FIG. 2C is a block diagram of a third digitizer that is suited for use in the FIG. 1 embodiment.

FIGS. 3A-3D illustrate the position of the read and write pointers in the time domain for a set of 5 buffers at four different points in time.

FIG. 4 is a memory map that shows one suitable arrangement of the buffers in the address space domain.

FIGS. 5A-5E illustrate the state of the write data in the buffers in the address space domain at five different points of time.

FIG. 5F is a detailed view of the write sequence to one section of a buffer in the address space domain.

FIGS. 6A-6D show how the FWD and REV buttons are used to navigate through the data in the selected buffer.

FIG. 7 shows how a single antenna feed is split so that it can be sent to multiple tuners.

FIG. 8 depicts a prior art packet-based broadcast that broadcasts multiple audio streams over a single transmission.

FIG. 9 is a block diagram of another embodiment of the invention for use with packet-based broadcasts.

FIG. 10 is a memory map showing how the packets are stored in the FIG. 9 embodiment.

FIG. 11 is an alternative station select control with a rotary dial.

FIG. 12A is an alternative station select control with a two-button interface.

FIG. 12B is a state diagram for the two-button station select control of FIG. 12A.

### DETAILED DESCRIPTION OF THE PREFERRED EMBODIMENTS

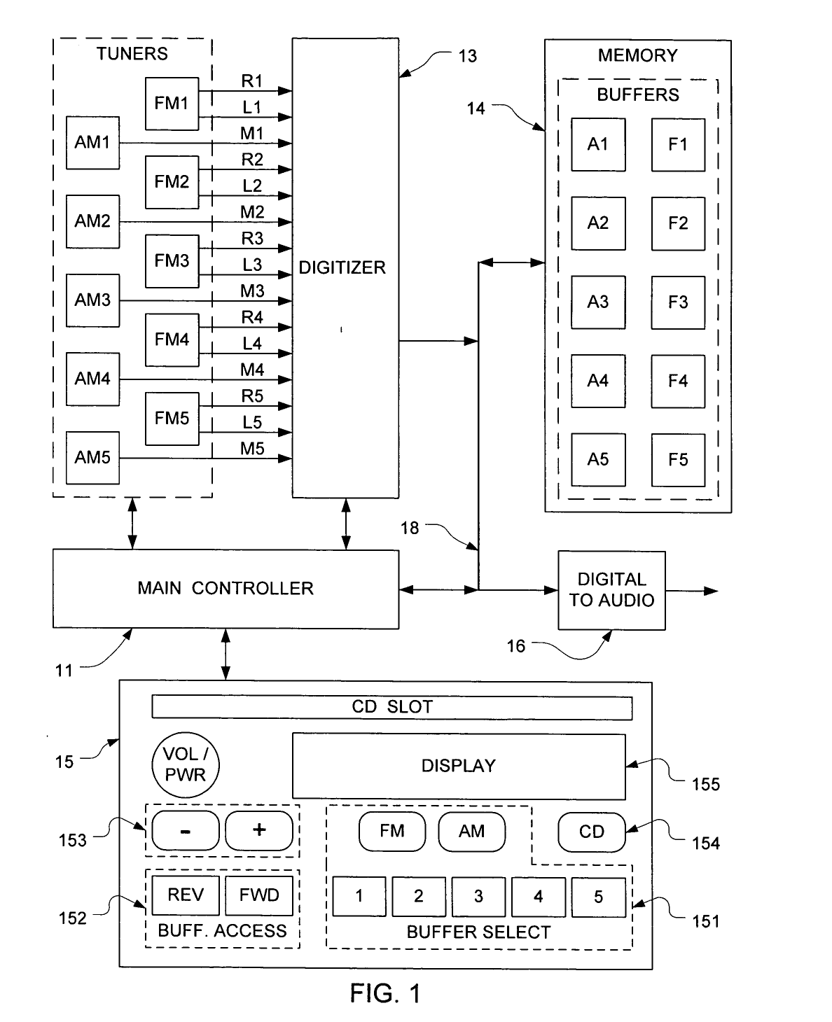

FIG. 1 is a block diagram of an embodiment of the invention implemented in a car radio. The device of FIG. 1 has five AM tuners AM1-AM5 and five FM tuners FM1-FM5. All of the tuners operate simultaneously and independently, which enables the device to receive ten different stations simultaneously. Although FIG. 1 depicts a total of ten tuners, different numbers of tuners may be used in alternative embodiments. At least 2 tuners are required, but using at least three tuners is preferred, and using at least five tuners is more preferred.

The main controller 11 controls which station each of the tuners AM1-AM5, FM1-FM5 is tuned to, preferably by sending appropriate control signals to each of the tuners. The control interface between the main controller 11 and the tuners AM1-AM5 and FM1-FM5 may be implemented in a variety of ways. One example of a suitable interface is to connect all of the tuners to a common bus (e.g., a serial bus), incorporate an addressable control interface into each of the tuners, and assign a unique address to each of the tuners. This arrangement permits the main controller to set any given tuner to a desired station by writing a control word to the address assigned to that tuner. The control interface for the tuners AM1-AM5 and FM1-FM5 may be modeled after conventional car radio tuners with digital tuning, in which pressing a single station-preset button on the control panel causes a controller (e.g., a microprocessor) to initiate a control sequence that causes the conventional tuner to tune to the desired station.

In the illustrated embodiment, the FM tuners FM1-FM5 are stereo, and the AM tuners AM1-AM5 are monophonic. As such, each FM tuner generates a pair of audio signals (labeled R and L in FIG. 1), and each AM tuner generates one audio signal (labeled M in FIG. 1). Taken together, the tuners AM1-AM5 and FM1-FM5 generate five mono audio streams and five stereo audio streams, wherein each stereo audio stream contains two audio signals. That comes to a total of fifteen audio signals for the illustrated embodiment. The circuitry in the tuners that converts the received radio waves into right and left audio signals for FM tuners and into mono audio signals for AM tuners is well known to persons skilled in the relevant arts.

The digitizer 13 digitizes each of the fifteen audio signals generated by the tuners AM1-AM5, FM1-FM5 at a sufficiently high sampling rate to permit subsequent reconstruction of the audio signal. In the United States, the audio signals produced by standard FM tuners have a bandwidth of about 15 kHz, and the audio signals produced by standard AM tuners have a bandwidth of about 5 kHz. As a result, the minimum sampling rate for the audio signals produced by the FM tuners is 30,000 samples per second (30 kSPS), and the minimum sampling rate for the audio signals produced by the AM tuners is 10 kSPS. Because the audio signals produced by the AM tuners and the FM tuners have different minimum sampling rates, the system could be configured to sample the various signals at different sampling rates. However, to simplify the design, the digitizers described herein are configured to sample all of the audio signals at the same sampling rate.

One appropriate sampling rate that may be used for all of the audio signals is 44.1 kSPS, which is the same sampling rate that is used for conventional compact disc (CD) audio. Using this sampling rate advantageously permits the use of standard CD playback hardware designs and algorithms to reconstruct the audio signals from the digital data. In alternative embodiments, the sampling rate may be reduced to about 33 kSPS to conserve memory (by reducing the volume of digital data that must be stored). However, using slower sampling rates will increase the complexity of the low pass filter that is used when the digital data is converted back into analog form. In other alternative embodiments, the sampling rate may be increased (e.g., oversampling may be used) to simplify the design of the filter, at the cost of increased memory requirements. Unless indicated otherwise, the discussion of the FIG. 1 embodiment that follows assumes that all data is sampled at 44.1 kSPS.

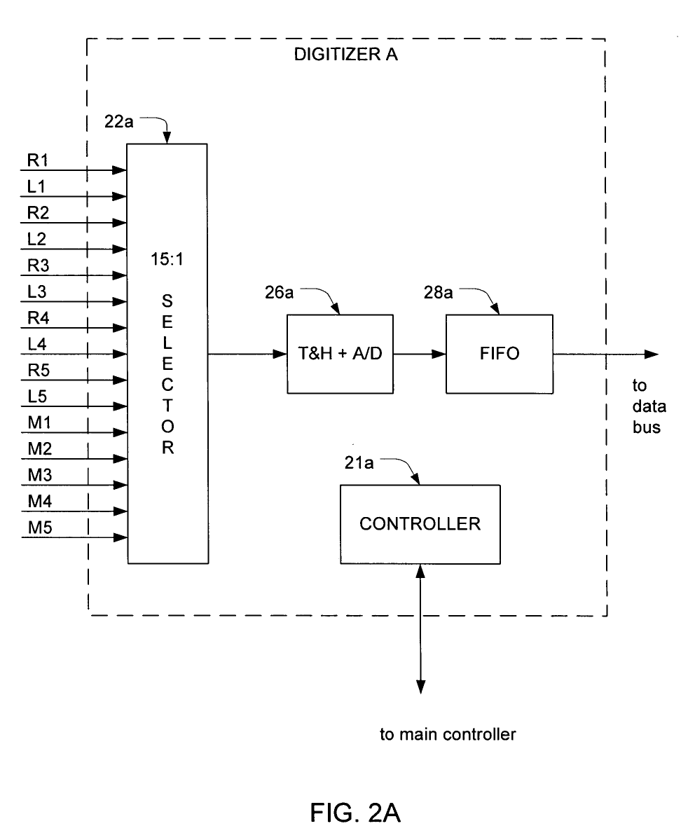

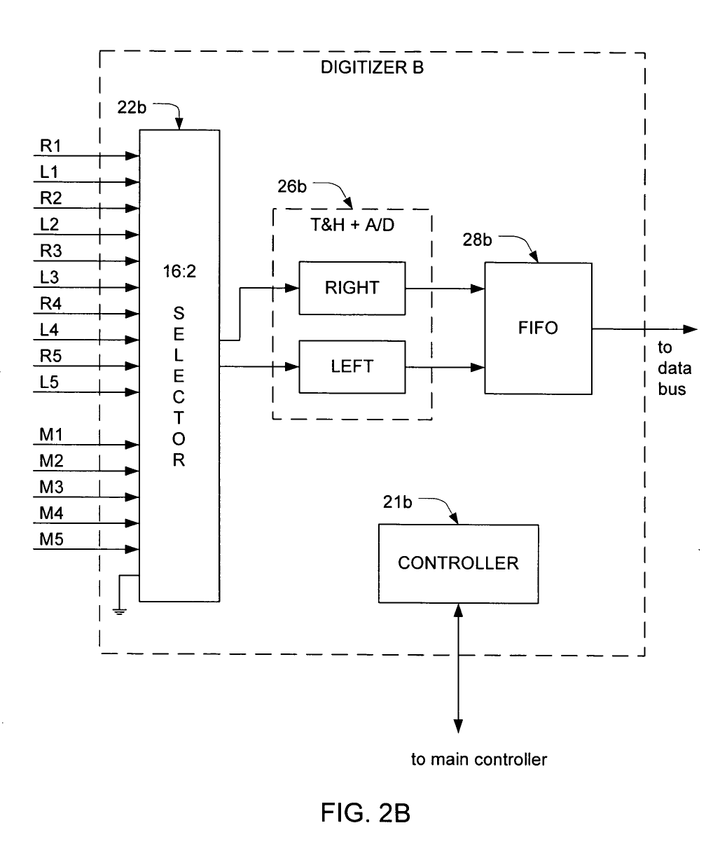

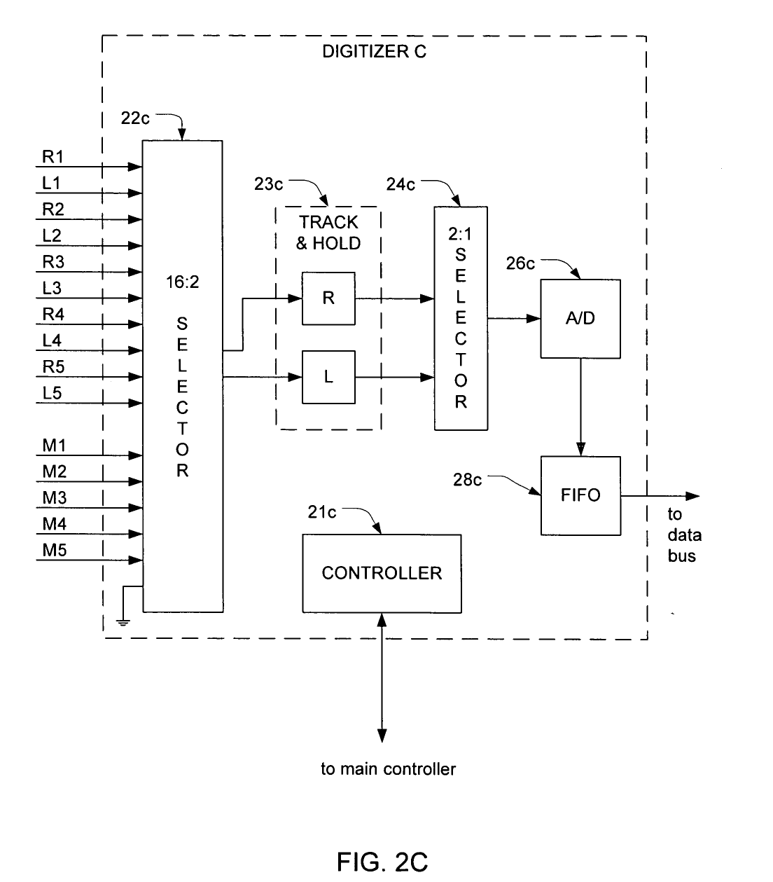

Preferably, the digitizer 13 includes at least one analog to digital (A/D) converter with 14-16 bits of resolution, which is adequate for AM and FM radio broadcasts. Lower resolution may also be used in alternative embodiments. Three examples of suitable configurations for the digitizer 13 are described in FIGS. 2A-2C, and other configurations will be apparent to persons skilled in the relevant arts.

The FIG. 2A embodiment uses a single A/D converter 26A with a built in track and hold. Preferably, the local controller 21A controls the operation of the other components in the digitizer A via control signals (not shown). The local controller 21A sets the selector 22A to one of the signals, then initiates an A/D conversion. When the conversion is complete, the result is clocked into the FIFO 28A. The local controller 21A then repeats this process for each of the signals in turn. After all fifteen signals have been sampled, and the fifteen results have been written into the FIFO 28A, the local controller 21A sends a signal (e.g., an interrupt) to the main controller 11. In response to this interrupt, the main controller reads the contents of the FIFO. Because there are 15 signals that each must be sampled at 44.1 kSPS, the A/D converter must perform 661,500 A/D conversions per second. One example of a suitable A/D converter for this application is the Analog Devices AD7485, which is rated at one million conversions per second.

The FIG. 2B embodiment arranges the signal into pairs, and uses two A/D converters 26B with built in track and holds. Preferably, the local controller 21B controls the operation of the other components in the digitizer B via control signals (not shown). The local controller 21B sets the selector 22B to one pair of signals, then initiates an A/D conversion in both A/D converters. When the conversions are complete, both results are written into the FIFO 28B. The remaining functions are similar to the FIG. 2A embodiment, but slower A/D converters can be used because each A/D converter only has to perform 352,800 A/D conversions per second to maintain the 44.1 kSPS rate for each signal. Notably, this embodiment samples both the right and left channels from each tuner at the exact same time.

The FIG. 2C embodiment also arranges the signal into pairs, but uses one A/D converter 26C and a pair of track and hold amplifiers 23C. Preferably, the local controller 21C controls the operation of the other components in the digitizer C via control signals (not shown). The local controller 21C sets the selector 22C to one pair of signals, then causes the track and hold amplifiers 23C to hold the voltage of each signal in the pair. Each of these held values is selected in turn by the 2:1 selector 24C and converted to by the A/D converter 26C, and the results of the conversions are stored in the FIFO 28C. The remaining functions are similar to the FIG. 2A embodiment. This embodiment also samples both the right and left channels from each tuner at the exact same time.

In alternative embodiments (not shown), the main controller 11 may be used to perform some or all of the functions of the local controller 21A, 21B, or 21C.

The memory 14 is logically organized as a set of buffers A1-A5, F1-F5. The digitized data that is generated by the digitizer 13 is stored in these buffers. The buffers A1-A5 hold the digital data that originated in tuners AM1-AM5, respectively; and the buffers F1-F5 hold the digital data that originated in tuners FM1-FM5, respectively. However, because each of the FM tuners FM1-FM5 generates two audio signals (i.e., right and left), each of the buffers F1-F5 preferably includes two sections (i.e., one for right and one for left). For example, the digital data that was obtained by digitizing the right channel from tuner FM2 would be stored in one section of buffer F2, and the digital data that was obtained by digitizing the left channel from tuner FM2 would be stored in the other section of buffer F2.

Data from the tuners is constantly being written into the buffers A1-A5, F1-F5, so a memory device that can sustain a large number of write cycles is needed. Semiconductor random access memory (RAM) such as static RAM (SRAM) and dynamic RAM (DRAM) is preferred, but other types of memory (e.g., a hard disk drive) may be used in alternative embodiments.

The main controller 11 preferably comprises a microprocessor, a microcontroller, or a digital signal processor (DSP) chip that is programmed to carry out the functions described herein. The program that the main controller 11 runs may be stored in any conventional manner, preferably in a nonvolatile memory such as ROM, PROM, or EPROM. The main controller 11 oversees and/or performs most of the functions described herein, including (1) generating the addresses for accessing data, (2) directing the data flow during recording by storing each word generated by the digitizer 13 into the appropriate buffer in the memory 14; (3) directing data flow during playback by reading the digital data out of whichever buffer has been selected for playback, and outputting the playback data to the digital-to-audio subsystem 16; (4) accepting instructions from the user and reporting status back to the user via the user interface 15; and (5) controlling the operation of the tuners AM1-AM5, FM1-FM5.

The main controller 11 preferably includes appropriate interfaces that enable it to carry out each of these functions. Of course, the specifics of these interfaces will depend on the components that are used in the rest of the system. For one example, if the memory 14 is implemented using DRAM, the main controller 11 would include a DRAM controller to facilitate access to the data in the DRAM; but if SRAM is used, no memory controller would be needed. For another example, if the tuner control is implemented via a serial bus, the main controller would include an appropriate UART. In certain embodiments, the hardware for the main controller may be distributed in more than one location (e.g., on two circuit boards). Because all these interfaces are well understood by persons skilled in the relevant arts, the selection and implementation of the appropriate interface need not be discussed here in greater detail.

In the FIG. 1 embodiment, the transfer of digitized audio data during recording and playback (i.e., the data flow between the digitizer 13, the controller 11, the memory 14, and the digital-to-audio subsystem 16) takes place over the high speed data bus 18. The control and status signals between the main controller 11 and the tuners AM1-AM5, FM1-FM5, the digitizer 13, and the user interface 15 are implemented using one or more lower speed data buses (e.g. serial data buses) and/or dedicated control lines. In alternative embodiments (not shown), some or all of the control and status functions may be implemented on the high-speed data bus 18.

The user controls the device via a user interface. Although a wide variety of user interfaces can be readily envisioned, one example of a suitable user interface is illustrated in FIG. 1. The user interface 15 of the FIG. 1 embodiment is a control panel that includes a set of control buttons 151, 152 to control playback of the buffered data. Additional control buttons 153, 154 provide control of other system functions. All keypresses are reported to the main controller 11, so that the main controller 11 can respond appropriately.

Preferably, the system is initialized prior to use by presetting the tuners AM1-AM5, FM1-FM5 to stations that the user prefers. The station presets are preferably stored in a non-volatile memory (e.g., flash EPROM, or battery-backed-up RAM). Some examples of ways for the user to set the tuners to the desired stations are discussed below. The discussion of the FIG. 1 embodiment that follows, however, assumes that all the tuners AM1-AM5 and FM1-FM5 have already been set to the desired stations.

Buffering the Audio Signals Generated by the Tuners

Mapping the logical buffers A1-A5, F1-F5 onto one or more physical memory devices may be implemented in any conventional manner. For example, if 32 Megabyte (Mb) DRAM memory chips are used, 16 such chips would be required to form a 256 Mb memory space.

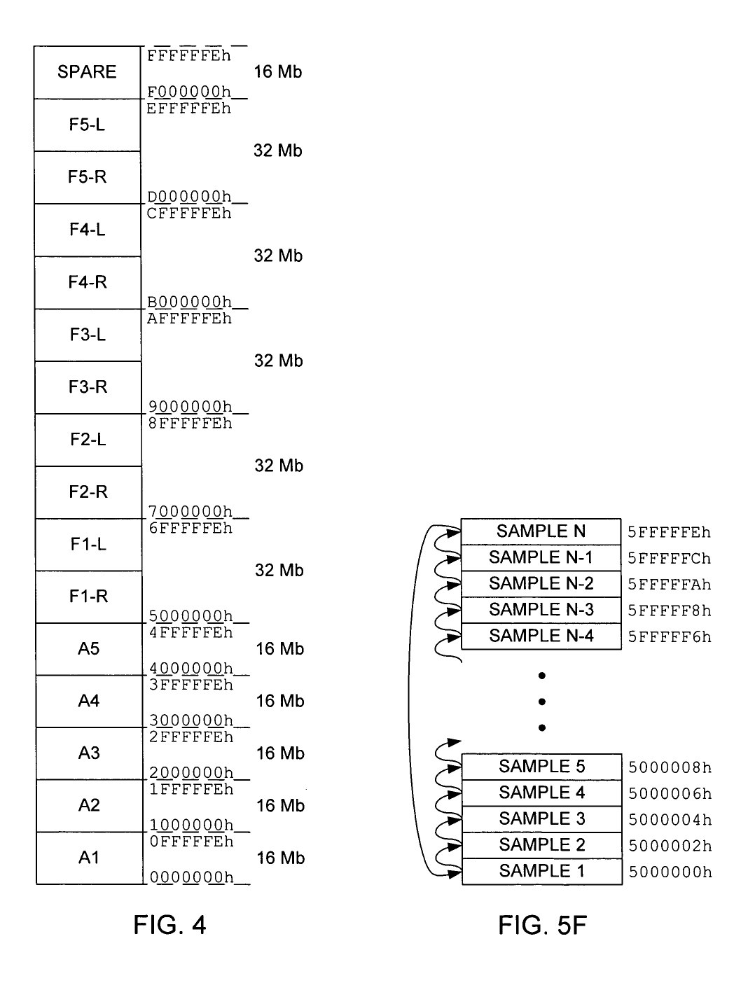

FIG. 4 is an example of one suitable memory map for mapping each of the logical buffers A1-A5 and F1-F5 onto a 256 Mb memory space. A 16 Mb block of physical memory is assigned to each of the monophonic logical buffers A1-A5, and a 32 Mb block of physical memory is assigned to each of the stereo logical buffers F1-F5. Each of the 32 Mb blocks for the stereo buffers is subdivided into two 16 Mb sections—one for the right channel and one for the left channel.

Because each audio sample preferably contains 14-16 bits, the memory is preferably organized in words that are two bytes wide, so that each word holds one sample. When the audio data is sampled at 44.1 kSPS with two bytes per sample, each 16 Mb block of data will hold 8 MegaSamples, which corresponds to about 190 seconds of audio data. In alternative embodiments, larger or smaller buffers may be used to provide different amounts of time.

When power is first applied to the device, none of the buffers contain useful information. The FIG. 1 embodiment requires fifteen write pointers: one for each of the five AM buffers A1-A5, one for the right (R) section of each of the five FM buffers F1-F5, and one for the left (L) section of each of the five FM buffers F1-F5.

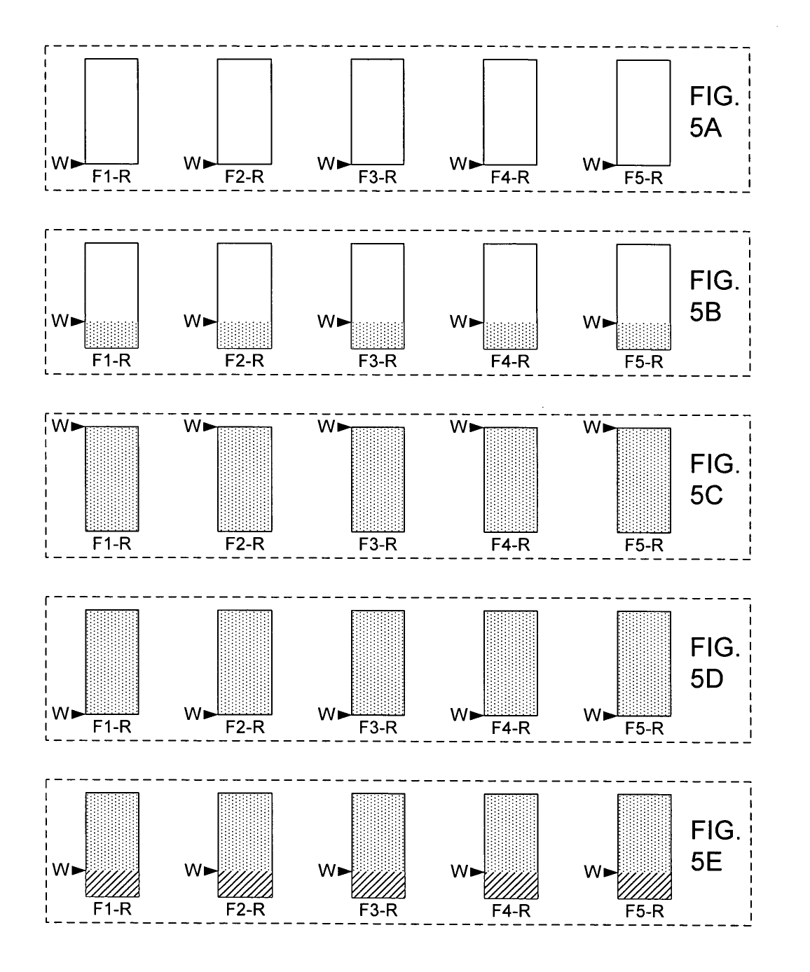

The write pointers for each of the AM buffers A1-A5 and for both sections of each of the FM buffers F1-F5 are reset to the first address in the buffer or section. For example in the memory map of FIG. 4A, the write pointer for buffer A3 would be reset to 2000000h, the write pointer for buffer F2-R would be reset to 7000000h, and the write pointer for buffer F2-L would be reset to 8000000h. FIG. 5A shows the state of the right section of each of the buffers F1-F5 at this point in time, with the white space corresponding to unwritten memory locations. Note that the AM buffers A1-A5 and the left section of the FM buffers are not shown in FIGS. 5A-5E, but operate in the same way as the illustrated sections F1-R through F5-R.

The digitizer 13 samples each of the audio signals. The samples from tuners AM1-AM5 are stored in buffers A1-A5, respectively; the samples from the right channel of tuners FM1-FM5 are stored in buffers F1-R through F5-R, respectively; and the samples from the left channel of tuners FM1-FM5 are stored in buffers F1-L through F5-L, respectively. After the write operation, the system samples the next data point from each of the audio signals and increments each write pointer, then stores the samples in the next location in each buffer. This process continues until the write pointer reaches the last address in the section, as shown in FIG. 5B where the sections are one quarter full, and in FIG. 5C where the sections are completely full. In these figures, the white space corresponds to unwritten memory locations, and the dotted space corresponds to memory locations that have been written to.

After writing to the last address in each section, the write pointers are all reset to the first address, as shown in FIG. 5D. As a result, when the next sample of data is stored in each section, it overwrites the oldest sample. The write pointer then continues incrementing as new data is written, as shown in FIG. 5E (where the new data is cross-hatched and the old data is dotted). With this arrangement, which is one implementation of a “circular buffer,” the AM buffers A1-A5 and each section of the FM buffers F1-F5 always contain the most recent 8 MegaSamples (i.e., about 190 seconds) of audio data. Depending on what type of memory is used, a short latency time (preferably less than 50 mSec) may be needed to write the data into the buffers.

FIG. 5F is a detailed illustration of how the memory is accessed for writing in the right (R) section of buffer F1. The numbers on the right side of the figure represent the memory addresses in hexadecimal, and the arrows on the left represent the movement of the write pointer. The circular nature of the write process can be seen from the fact that the write pointer increments to the next address for each sample until the end of the buffer is encountered, at which point the write pointer returns to the first address in the buffer. Note that the addresses increments by two after each write because each sample contains two bytes. The write pointers for each of the AM buffers A1-A5 and the other section of the FM buffers F1-F5 operate in a similar fashion (each within its own address space).

Alternative architectures for storing the newest data and discarding the oldest data so that the most recent interval of audio data is always maintained in memory may be implemented, as will be apparent to persons skilled in the relevant arts.

Playback of the Buffered Data

The FIG. 1 embodiment is preferably configured so that, from the perspective of the user, pressing the buffer select buttons 151 brings about a similar end result as the correspondingly labeled buttons on a conventional car radio. More specifically, in a conventional car radio, pressing a numbered station preset button causes the radio to start playing the station that was preset for that button, and pressing a band-select button (e.g., dedicated AM and FM buttons, or an AM/FM toggle button) causes a conventional car radio to switch bands and tune to the most-recently selected station for the newly selected band. Similarly, in the FIG. 1 embodiment, pressing one of the numbered buffer select buttons 151 causes the device to play the station that was preset for that button, and the AM or FM buffer select buttons 151 causes the device to switch bands. However, the mechanism for achieving this similar end result for the user differs for the FIG. 1 embodiment.

In the FIG. 1 embodiment, pressing one of the numbered buffer select buttons 151 selects the corresponding buffer for playback. For example, assuming that the user is currently listening to an FM station, pressing the buffer select button 151 labeled “1” will cause the system to start reading data out of buffer F1, pressing the buffer select button 151 labeled “2” will cause the system to start reading data out of buffer F2, etc. If the user presses the buffer select button 151 labeled “AM”, the system will switch to AM playback mode and start reading data out of the most-recently-used AM buffer.

In the AM playback mode, pressing the buffer select button 151 labeled “1” will cause the system to start reading data out of buffer A1, pressing the buffer select button 151 labeled “2” will cause the system to start reading data out of buffer A2, etc. If the user presses the buffer select button 151 labeled “FM”, the system will switch back to FM playback mode and start reading data out of the most-recently-used FM buffer.

As discussed above, the FIG. 1 embodiment has fifteen write pointers—one for each of the AM buffers A1-A5 and two for each of the FM buffers F1-F5. However, only two read pointers are used during playback from the FM buffers (one for the right section and one for the left section), and only one read pointer is used during playback from the AM buffers.

When a station is initially selected using the buffer select buttons 151, the read pointers are positioned to access the selected buffer, and also positioned to lag behind the write pointers so that current data is read. As new data for the selected buffer arrives, the write pointers continue to increment at a rate of 44.1 K words per second. The read pointers are also incremented at the same rate, so they will always lag behind the write pointers by a constant amount. The distance (in memory locations) between the read pointers and the write pointers is preferably as small as possible, after accounting for the memory technology being used. For example, if SRAM memory is used, the read pointers may be set to lag behind the write pointers by one or two words. If a hard disk memory is used, it may be necessary to have the read pointers lag behind the write pointers by a significant amount (e.g., a few thousand samples) to allow time to reposition the heads as required. While shorter lag times are preferred, long lag times (e.g., on the order of seconds) may be used in alternative embodiments. However, whatever minimum lag time is implemented for a given embodiment, when the read pointers lag behind the write pointers by the minimum lag time, the data that the read pointers point to is referred to herein as “current data.”

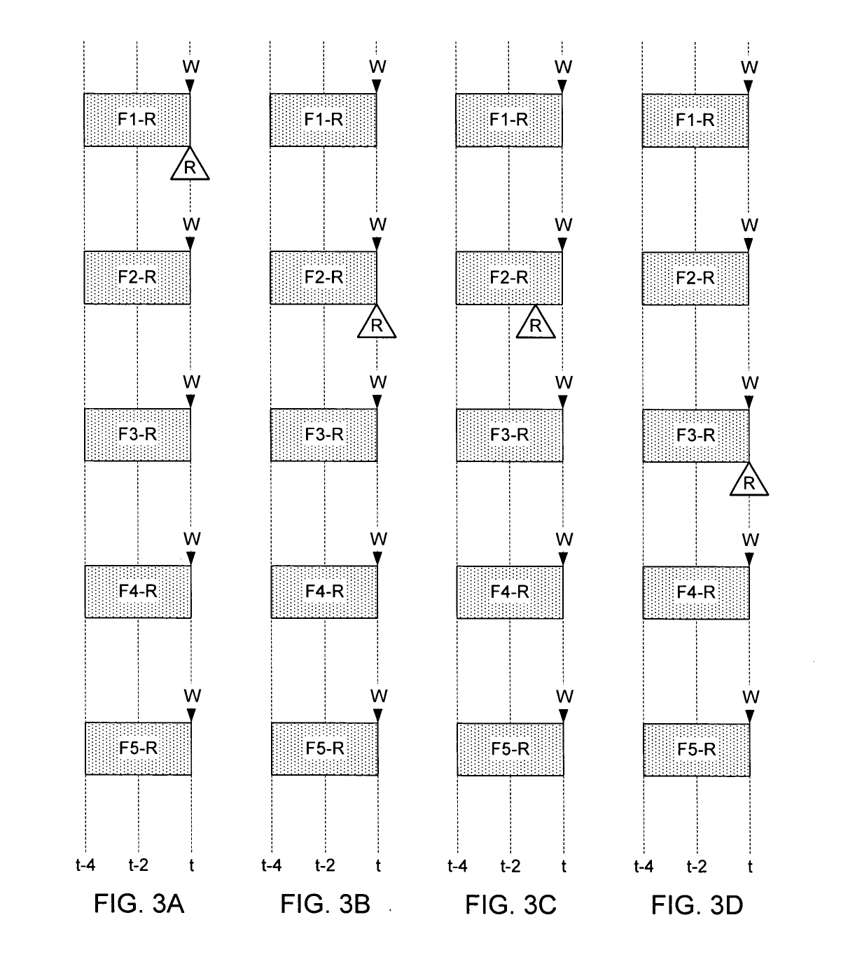

When a different station is selected using the buffer select buttons 151, the read pointers are preferably positioned to point to the current data in the newly selected buffer. For example, if a read pointer is positioned to access the current data in buffer F1-R, as shown in FIG. 3A, pressing the buffer select button 151 labeled “2” would initiate a control sequence that repositions the read pointer to access the current data in buffer F2-R, as shown in FIG. 3B. Similarly, if a read pointer is positioned to access older (i.e., non-current) data in buffer F2-R, as shown in FIG. 3C, pressing the buffer select button 151 labeled “3” would initiate a control sequence that repositions the read pointer to access the current data in buffer F3-R, as shown in FIG. 3D.

Data is read by the main controller 11 from the currently selected buffer at the position of the read pointer (for the AM buffers A1-A5) or the read pointer pair (for the FM buffers F1-F5). After reading a data sample (from the AM buffer) or a sample pair (from an FM buffer) the read data is output to the digital-to-audio subsystem 16. After each read operation, the default operation is to increment the read pointer (or pointers) to point to the next sample (or pair of samples) in the currently selected buffer. However, as with the write pointers, if a read pointer reaches the last address in a buffer, it is reset to point back to the first location in the buffer instead of being incremented. Of course, any user command that results in repositioning of the read pointers (either to a different buffer or to another location in the same buffer) also interrupts the default incrementing process for the read pointers.

The read data is output to the digital-to-audio subsystem 16 at a rate of 44.1 kSPS per channel, which is the same rate at which the data was sampled. In embodiments where the digital-to-audio subsystem 16 operates asynchronously with respect to the main controller 11, synchronization is preferred to insure that the output data samples are always generated at exactly 44.1 kHz. An example of a suitable synchronization system that may be incorporated into the digital-to-audio subsystem 16 is a double buffer in which the first stage is a 16 bit latch that is written to by the main controller 11, and the second stage is a 16 bit D-type register that is clocked at 44.1 kHz. With this arrangement, as long as the main controller 11 writes the data into the latch within the appropriate window of time, it will be clocked out of the D-type register at the correct instant.

The digital-to-audio subsystem 16 converts the stream of samples to an analog signal (or a pair of analog signals for FM stations). Conversion of the samples to analog form may be implemented, for example, using conventional CD audio hardware (such as a digital-to-analog converter followed by a low-pass filter). Optionally, conventional CD algorithms (e.g., interpolation) for eliminating pops and clicks may also be used. The audio signals are then amplified and sent to a speaker (not shown) in any conventional manner.

Because the default condition is to read a sample from the currently selected buffer, output it at a rate of 44.1 kSPS to the digital-to-audio subsystem 16, and then continue on to the next sample, the audio signal that is generated with be the same as the audio signal that was originally digitized and written into the selected buffer. As a result, operating the buffer select buttons 151 of the FIG. 1 embodiment produces an output that appears almost identical to the output produced by a conventional car radio in response to similarly labeled buttons (unless the time lag between the write pointer and the read pointer is large enough to be noticeable). It thereby produces a substantially current version of the audio stream that was most-recently selected using the buffer select buttons 151.

However, the FIG. 1 embodiment also contains buffer access buttons 152, which provide additional functionality that is not implemented in conventional car radios. Assuming that the desired buffer has been selected for playback, the buffer access buttons 152 are used to control which portion of the data from that buffer is played. In the FIG. 1 embodiment, the buffer access button 152 labeled REV provides access to portions of the buffer that preceded the current data by moving the read pointer backwards in time within the buffer, and the buffer access button 152 labeled FWD moves the read pointer forwards in time within the buffer.

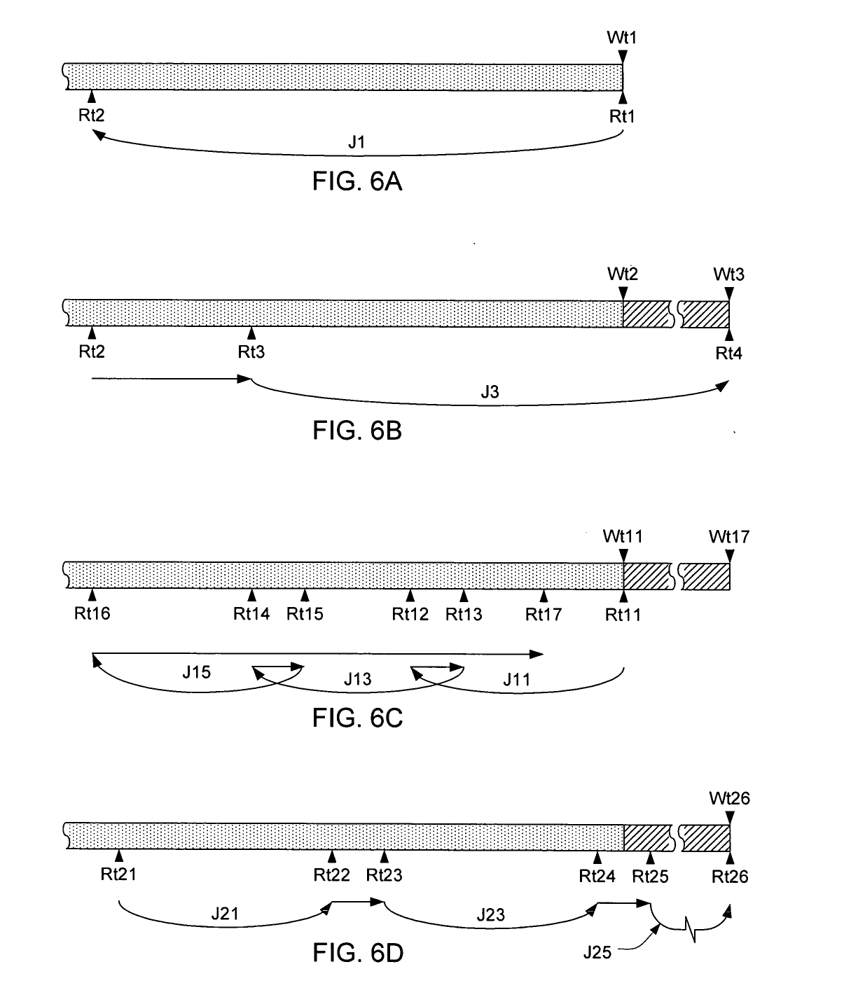

As with conventional CD players and car stereos, a single button can be used to initiate two functions: one when the button is pressed momentarily, and a second when the button is pressed and held. In some embodiments, a sustained press initiates short jumps with audio feedback to help the user locate the desired portion of the buffered program, and a momentary press initiates a typically longer jump with no audio feedback. Note that in FIGS. 6A-6D, higher “t” numbers (e.g., t17 t26 etc.) correspond to events that are later in time.

FIGS. 6A and 6B illustrate a sequence of events that occur at times t1 through t4 in response to momentary presses of the buffer access buttons 152. At time t1 in FIG. 6A, the write pointer is at location Wt1, and the read pointer lags closely behind at location Rt1 as described above. When the REV button is pressed momentary, the read pointer is moved back within the currently selected circular buffer by a predetermined number of addresses (e.g., the number of addresses that corresponds to twenty seconds). This is illustrated in FIG. 6A where the jump J1 takes the read pointer directly to location Rt2. Each subsequent press (not shown) of the REV button will move the pointers an additional twenty seconds back within the currently selected buffer until the end of the buffer is reached. Thus, the system will generate a delayed version of the audio stream that was most-recently selected using the buffer select buttons 151, with the amount of delay increasing with each press of the REV button up to the maximum possible within the confines of the data stored in the buffers.

FIG. 6B depict the events that occur after the read pointer has jumped. Reading continues from time t2 to time t3 by incrementing the read pointer after each data sample is read, and outputting the samples to the digital-to-audio subsystem 16 at a rate of 44.1 kSPS per channel. Thus, from time t2 to time t3, the system is pointing to and outputting data that was recorded twenty seconds ago. In the meantime, new data continues to arrive from the tuners, and the write pointer increments from Wt2 to Wt3 as the new data is written to the buffer, as described above. At time t3, the user presses the FWD button momentarily, which causes the read pointer to jump forward within the currently selected circular buffer by the same predetermined number of addresses. This is illustrated by the jump J3, which brings the read pointer to position Rt4. Playback of the current data then continues as before. Note that although it is not depicted in the figures, the write pointer at time t4 will be just one sample past position Wt3 (to the right).

In one alternative embodiment, a momentary press of the REV button may cause the read pointer to jump to the oldest portion of the currently selected buffer. In another alternative embodiment, preferably implemented using a DSP-based main controller 11, the system monitors the write samples before storing them in the buffers, and runs pattern recognition software to detect the transitions between songs (e.g., by detecting pauses or changes in the frequency spectra of the audio data). Each time a transition is detected, the address corresponding to the transition is stored in memory (e.g., in the spare section mentioned above). In this embodiment, a momentary press of the REV button causes the system to look in the transition table and move the read pointer backwards to the most recent transition for the currently selected buffer. Additional presses of the REV button will move the read pointer backwards to previous transitions or to the oldest end of the buffer (which corresponds to the maximum delay with respect to the current version), whichever is encountered first. Similarly, pressing the FWD button will move the read pointer forward within the buffer to the next transition or to the newest end of the buffer, whichever is encountered first.

In a similar alternative embodiment, the transitions between songs can be detected based on supplemental data that is transmitted in connection with the radio broadcast. For example, in recent years many FM stations have started transmitting low bit-rate supplemental digital data that specifies the title of the song and the artist, so that the data can be displayed on compatible receivers. Since new supplemental data will typically accompany the start of a song, transitions in this supplemental digital data can be used to find song-to-song transitions. When those transitions are detected, the corresponding addresses are loaded into the transition table, and subsequently used as described in the previous paragraph to access the stored data on a song by song basis.

FIG. 6C illustrates a sequence of events that occur at times t11 through t17 in response to sustained presses of the REV buffer access button 152, which operates similarly to the reverse search function with audio feedback on conventional CD players. At time t11, the write pointer is at location Wt11, and the read pointer lags closely behind at location Rt11 as described above. When the REV button is pressed and held, the read pointer is moved back within the currently selected circular buffer (e.g., by the number of addresses that corresponds to 3 seconds) via jump J11, which increases the delay of the data being output with respect to the current version of the broadcast. After the jump, a short section of data between position Rt12 and Rt13 is sequentially accessed and output to the digital-to-audio subsystem 16. This jump back and play sequence continues until the user releases the REV button at time t16. Playback then continues from time t16 through time t17 by sequentially accessing and outputting the corresponding data from the currently-selected buffer to the digital-to-audio subsystem 16. In the meantime, new data is being constantly added to the buffers as the write pointers are incremented from position Wt11 to Wt17.

Once a user has backed away from the current data and into the older data using the REV button as described above, the FWD button becomes available to move the read pointer forwards through the buffer, which decreases the delay of the data being output with respect to the current version of the broadcast. FIG. 6D illustrates the forward movement of the read pointer, which is similar to the backwards motion discussed above in connection with FIG. 6C. The forward search with audio feedback mode uses relatively long forward jumps J21, J23, and short playback periods (e.g., between times t22 and t23). Of course, any forward jump that might otherwise land the read pointer past the write pointer cannot be implemented, and must be shortened (like jump J25) so that the read pointer at position Rt26 lags behind the write pointer at position Wt26.

One suitable user interface approach for presetting the tuners AM1-AM5, FM1-FM5 to stations that the user likes is by having the user switch to the desired band by pressing the AM or FM buffer select button 151, and then pressing and holding one of the numbered buffer select buttons 151 for a predetermined period of time (e.g., two full seconds) to enter a station-select mode for the correspondingly numbered tuner. In response to these keypresses, the main controller 11 executes a station select routine. During this station select routine, the previously programmed station for the selected tuner is displayed on display 155, preferably flashing, and current data for the tuner is selected for outputting. The user than presses the + and − buttons 153 until the desired frequency is displayed on the display 155. In response to the + and − key presses, the main controller tunes the currently selected tuner to higher or lower frequencies, and adjusts the display 155 accordingly. The main controller 11 exits the station-select routine after a predetermined period of time (e.g., five seconds) has elapsed without detecting any key presses on the + and − buttons 153, at which point the flashing of the display 155 stops.

Another suitable user interface approach for presetting the tuners AM1-AM5, FM1-FM5 to desired stations uses an additional AM tuner AM6 and an additional FM tuner FM6 (not shown) and additional buffers A6 and F6 (not shown). In this embodiment, the user presses the + and − buttons 153 at any time to adjust the tuning. The frequency is displayed on the display 155, and the extra tuner is tuned to the selected station and its output is stored in one of the extra buffers. Once the extra buffer has filled up sufficiently, the buffered playback functions described above become available for the manually tuned station. When a user wished to program a manually tuned station into one of the five preset slots, the user presses the corresponding numbered buffer select button 151 for a predetermined period of time (e.g., two full seconds). This user interface is advantageously similar to the way the preset stations are programmed on conventional car radios. Preferably, whatever contents of the buffer have been accumulated before holding the buffer select button 151 are immediately available for access for the newly preset station. Numerous alternative user interface arrangements for setting the tuners to the desired stations can be readily envisioned.

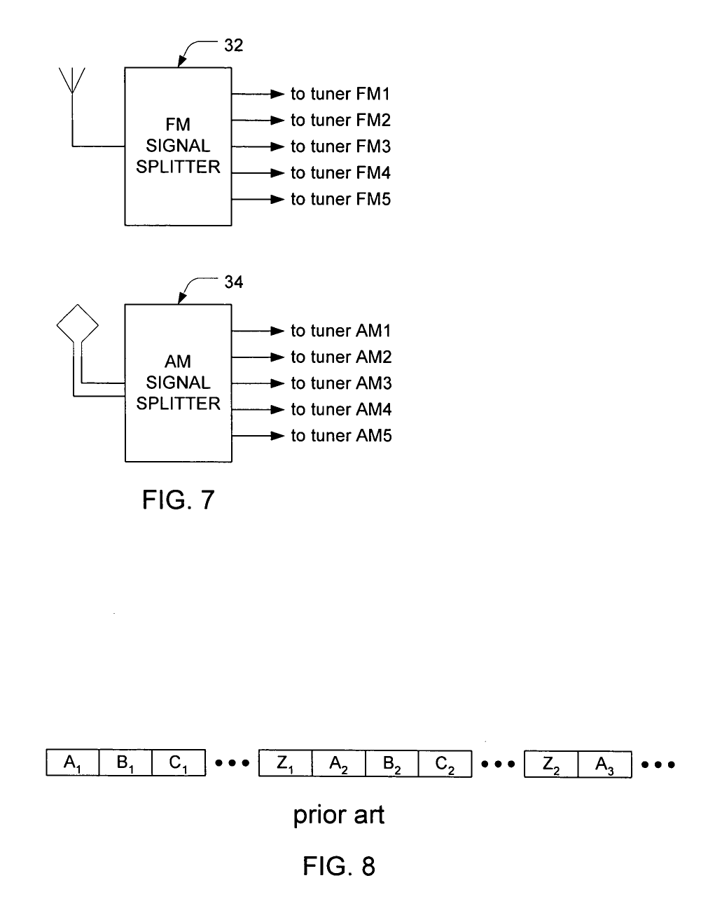

FIG. 7 shows how a single FM antenna feed may be split by an FM splitter 32 so that it can be sent to multiple tuners. A single AM antenna feed may similarly be split by an AM splitter 34 so that it can be sent to multiple tuners. Optionally, a preamplifier (not shown) may be added to boost the signals to the tuner.

In some alternative embodiments (not shown) buffering is only implemented for the FM stations. In these embodiments, only a single, conventional, AM tuner is used, and the buffers A1-A5 are omitted.

In other alternative embodiments, multi-band tuners that can receive either AM or FM signals (depending on the state of a control signal that arrives from the main controller 11) are used in place of the dedicated AM and FM tuners depicted in FIG. 1. This arrangement allows a user to, for example, preset eight FM stations and two AM stations. In these embodiments, a constant buffer size may be used for all preset stations, or the memory may be allocated on the fly so that the buffers for stereo stations have twice as much memory as the buffers for mono stations.

In some alternative embodiments, the digital data from the currently selected tuner is used to generate the audio output before the data is buffered, by outputting it to the digital-to-audio subsystem 16 as soon as it arrives. This results in a system with zero lag time between the arrival of the signal and the time that it is output. The data from buffers is only used after the user presses the REV button to access previously broadcasted portions of the program, in which case a delayed version of the most recently selected audio stream will be output.

In other alternative embodiments, when the user presses one of the buffer select buttons 151, the analog output of the newly selected tuner is routed to the audio amp via an analog selector (instead of using the current digital data that has been written to the buffers). These embodiments also have zero lag time, and the data from buffers is only used to generate an audio output after the user presses the REV button to access previously broadcasted portions of the program.

Optionally, stereo AM tuners (not shown) may be used, in which case the AM buffers would preferably also contain two sections.

Optionally, DMA capabilities may be added to the digitizer, so that the digitized data can be written to the buffers without using the resources of the controller.

Optionally, the audio data may be compressed before it is stored (e.g., in MP3 format) and decompressed when it is reproduced. This will save memory and increase storage capacity, but will also increase system complexity and latency.

Optionally, when the user powers down the system, the system may be programmed to switch to a standby mode instead of turning everything off. In the standby mode, all the tuners, the digitizer 13, the main controller 11, and the memory 14 are operational, and the system receives and buffers the incoming signals. When this option is implemented, the buffers will be full when the user turns the system on, so the user will be able to use the REV button immediately (instead of having to wait for the buffers to fill). In automotive applications where power drain must be minimized when the car is off (to prevent draining the car's battery), the use of low power circuitry for these subsystems is preferred. Optionally, a local rechargeable battery that charges when the car is running may be used to power the system in the standby mode, so that the system does not draw power from the car's battery when the car is off.

Preferably, all the tuners, the digitizer 13, the memory 14, and the main controller 111 are all housed in a single housing and share the same power supply circuitry. Most preferably, the housing is small enough to fit in the same space as a conventional car radio. Optionally, a CD player may be integrated into the same housing, as shown in FIG. 1.

A variety of alternative approaches for receiving a plurality of audio streams may be used instead of using the five AM and five FM tuners shown in the FIG. 1 embodiment. For example, one or more of the five FM tuners FM1-FM5 in the FIG. 1 embodiment may be replaced with one or more digital receivers using, for example, iBiquity Digital Corporation's HD digital radio technology, or an appropriate alternative approach. The baseband analog outputs from these receivers may be processed in the same way as the analog signals that are generated by the FM tuners in the FIG. 1 embodiment. Alternatively, instead of reconstituting the analog signal from the received digital data, re-digitizing the resulting analog signal, and storing the results of the digitization, the received digital data can be buffered in its digital form, before ever being converted to an analog form. Optionally, the digital data may be reformatted before being stored in the buffers. The received digital data is then maintained in digital form until playback of a particular audio stream is requested, and is only reconstituted into an analog signal during reproduction. When the broadcasted digital data is compressed (as it is in iBiquity digital HD), this approach permits the use of smaller memories and/or permits the implementation of longer buffers (measured in time) for a given storage capacity.

Certain prior art digital radio systems broadcast a large number of audio streams (e.g., over 100) together in a single transmission using digital data packets. FIG. 8 shows how the packets might be arranged in this type of prior art system, in an example that depicts 26 audio streams (A through Z) being broadcast together. The data is typically compressed. In this example, the first packet (with a subscript of 1) is sent for each of the streams A through Z, followed by the second packet (with a subscript of 2) for each of the streams, followed by the third packet etc. Note that while the data packets for any given subscript (e.g., Cⱼ and Pⱼ) may not arrive at the exact same instant, it can still be said that the data for stream C arrives substantially simultaneously with the data for stream P in the context of the audio signals that are represented by that data.

During conventional playback on this type of digital radio system, the data packets that correspond to the currently-selected audio stream are extracted from the entirety of the received digital data, and the extracted packets are reconstituted into analog output signals. The rest of the packets are not used to generate audio outputs.

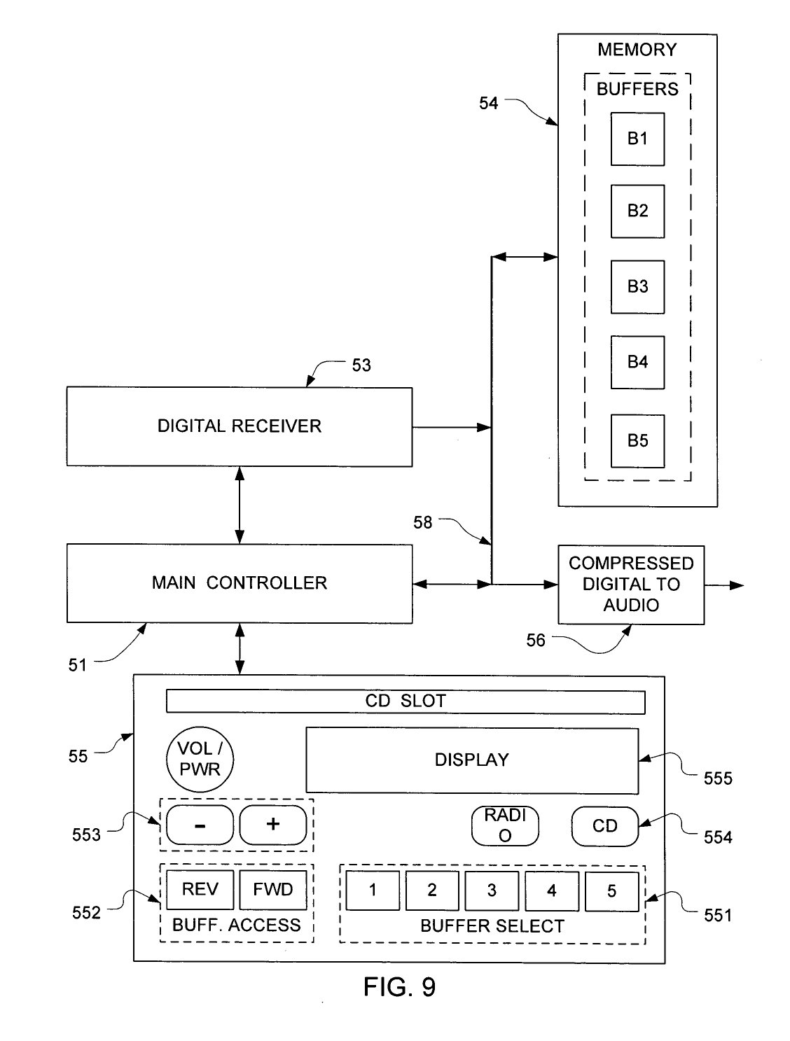

FIG. 9 is a block diagram of an additional preferred embodiment that receives digital broadcasts of many audio streams together in a single transmission, and provides functionality that is similar to the FIG. 1 embodiment. The reader will recall that The FIG. 1 embodiment had to use multiple tuners (one for each preset station) and then digitize the outputs of those tuners in order to obtain digital data for each of the audio streams. That digital data was then buffered. The FIG. 9 embodiment is similar, except in the FIG. 9 embodiment, it is easier to obtain digital data for the audio streams that correspond to the preset stations, because the data arrives in digital form. As a result, no digitizer is required.

The digital receiver 53 receives the entire stream of packets. In the example that follows, we assume that the 26 stream digital signal shown in FIG. 8 is received by the digital receiver 53 shown in FIG. 9. We further assume that the user has previously set the five preset pushbuttons 551 on the front panel user interface 55, so that pressing the buttons labeled 1, 2, 3, 4, or 5 would select streams C, E, H, P, or T, respectively. The main controller 51 knows which streams have been preset, so it examines the incoming data stream (e.g., by looking at the headers) and stores all of the packets that correspond to streams C, E, H, P, and T in the memory 54. Optionally, the digital data may be reformatted before being stored. The packets that correspond to the remaining 21 streams are not stored in the memory 54.

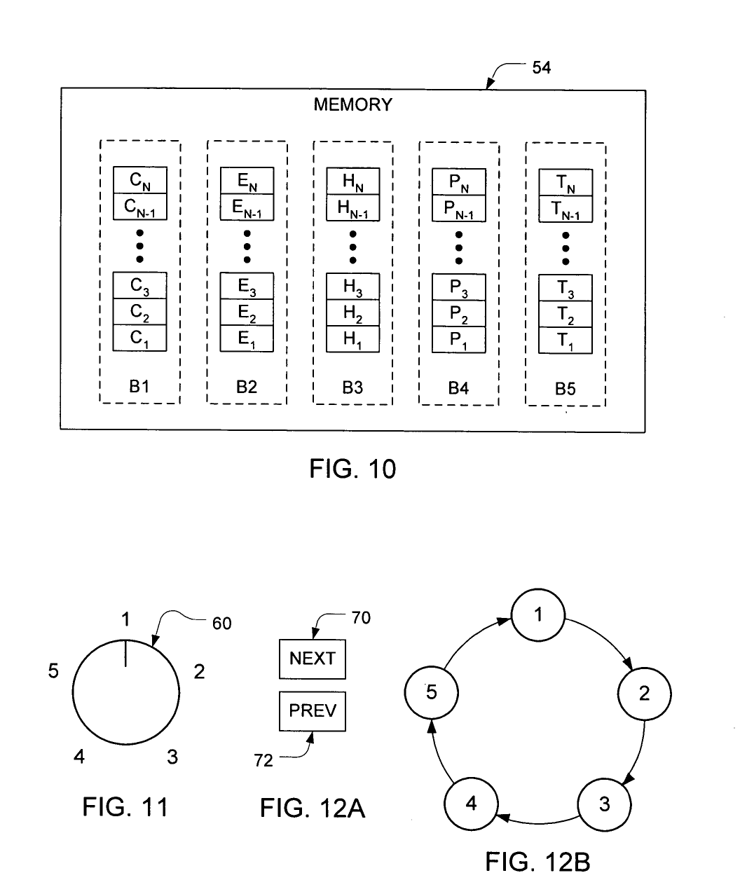

FIG. 10 shows a suitable memory map for arranging the packets into a plurality of logical buffers within in the memory 54. Since there are five presets in this example (i.e., streams C, E, H, P, and T), the memory 54 is arranged as five buffers B1-B5, and all the packets that correspond to those presets are stored in those buffers. At the moment in time illustrated in FIG. 10, the 1^{st} sample through the N^{th} sample have been stored in the buffers B1-B5. The buffers B1-B5 are preferably set up as circular buffers to hold the most recent few minutes of data from the preset streams, so after the buffers fill up, the oldest data (the samples with the lowest subscript) will be overwritten with more recent data. The implementation of circular buffers is discussed above in connection with the FIG. 1 embodiment, and is also well known to persons skilled in the relevant arts.

The user selects which audio stream he wants to listen to by pressing one of the buffer select buttons 551. The user interface 55 reports which button has been pressed to the main controller 51. The main controller then routes the current data from the corresponding buffer (B1, B2, B3, B4, or B5) to a subsystem 56 that reconstitutes the stored data for the corresponding stream into analog audio outputs. In alternative embodiments, a parallel version of the data may be routed directly to the subsystem 56 (without first being stored in the buffers) to produce the current version of the most-recently selected audio stream. When the data is stored in a compressed form, the subsystem 56 must include appropriate decompression, the implementation of which is well known to persons skilled in the relevant arts. Storing the data in its compressed form advantageously reduces the system memory requirements, and also reduces processing requirements since only one stream will have to be decompressed at any given time (i.e., only the stream that is currently being reproduced will require decompression).

The rewind and fast-forward functions in this embodiment are implemented using the buffer access buttons 552 in a manner that is similar to the FIG. 1 embodiment. Operation of the remaining control buttons 553, 554 and the display 555 are similar to the corresponding buttons 153, 154 and the display 155 in the FIG. 1 embodiment.

FIG. 11 shows an alternative rotary station select control that may be used in place of the pushbutton station select interface (i.e., the buffer select buttons 151, 551 shown in FIGS. 1 and 9, respectively). In this embodiment, turning the knob 60 to positions 1, 2, 3, 4, or 5 will select audio streams 1, 2, 3, 4, or 5, respectively. The appropriate changes needed to implement such a rotary control in place of a pushbutton interface will be readily apparent to persons skilled in the relevant arts.

FIG. 12A shows another alternative station select control that may be used in place of the pushbutton station select interface shown in FIGS. 1 and 9. In this embodiment, each of the preset stations is assigned a position in a sequence, and pressing the NEXT button 70 causes the system to go to the next audio stream in the sequence. FIG. 12B is a state diagram that shows the operation of such an interface when there are five presets, with a numbered state corresponding to each of the presets. Assuming that the system starts in state 1 where the audio stream for preset 1 is being output, subsequent presses of the NEXT button 70 will step through states 2, 3, 4, and 5, as indicated by the arrow heads between the states in FIG. 12B. This will cause the system to reproduce streams 2, 3, 4, and 5 in turn. The fifth press of the NEXT button 70 will return the system to state 1. Optionally, a PREV button 72 (shown in FIG. 12A) may also be provided to step through the states in the reverse sequence. This arrangement provides the same number of presets as the FIGS. 1 and 9 embodiments, but does not allow random access to the presets. Of course, an alternative actuator (e.g., a rocker or toggle switch) may be used instead of the two pushbuttons 70, 72 shown in FIG. 12A.

When the user interface of FIGS. 12A, 12B is used, the number of presets can be allocated during use. For example, if a user has only programmed three presets, the system would preferably be configured so that the NEXT button 70 would initiate a change from state 3 directly to state 1. When fewer presets are used, the unused memory is preferably dynamically allocated to the remaining presets. Alternatively, the user may be provided with the option to program more than 5 presets, in which case the system is preferably be configured so that the NEXT button 70 steps through all the presets in forward sequence, and the PREV button 72 steps through those states in reverse sequence. For example, if a user has selected eight presets, repeated actuation of the NEXT button 70 would step the system through presets 1, 2, 3, 4, 5, 6, 7, and 8 in turn, and the next actuation would return the system to preset 1. When more presets are used, the memory is preferably dynamically allocated among all the presets.

Because many listeners spend the vast majority of the time listening to a relatively small number of preset stations (e.g., 5-10), the fact that the above-described embodiments only buffer a limited number of preset stations should not pose a problem. In alternative embodiments, the number of buffers can be increased to suit the demands of unusual users.

The invention is not limited to the specific embodiments described above, and various alternative embodiments may be implemented without departing from the scope and spirit of the invention, as will be understood by persons skilled in the relevant arts.

1. A buffered radio apparatus comprising:
at least one radio receiver, wherein the at least one receiver receives, substantially simultaneously, broadcasts of a first audio stream, a second audio stream, and a third audio stream;
a memory in which data representing the first, second, and third audio streams is stored, wherein the memory is continuously updated so that data representing the most recent at least twenty seconds of the first, second, and third audio streams is maintained in the memory;
a user interface that includes (a) a stream-select control that enables a user to select a desired audio stream and (b) a delay control that enables the user to request reproduction of a delayed version of whatever audio stream was most recently selected by the user; and
a reproduction subsystem that, in response to actuation of the stream-select control, outputs a substantially current version of the audio stream selected by the user, wherein, in response to actuation of the delay control, the reproduction subsystem outputs a delayed version of the most recently selected audio stream based on the data representing the most recently selected audio stream that is stored in the memory.

2. The apparatus of claim 1, wherein the stream-select control comprises a first button for selecting the first audio stream, a second button for selecting the second audio stream, and a third button for selecting the third audio stream.

3. The apparatus of claim 2, wherein the delay of the delayed version of the most recently selected audio stream with respect to the current version of the most recently selected audio stream is adjustable, within the confines of the data maintained in the memory, based on user actuation of the delay control.

4. The apparatus of claim 3, wherein the memory is continuously updated so that data representing the most recent at least about three minutes of the first, second, and third audio streams is maintained in the memory.

5. The apparatus of claim 1, wherein the stream-select control comprises a rotary control having a first position for selecting the first audio stream, a second position for selecting the second audio stream, and a third position for selecting the third audio stream.

6. The apparatus of claim 5, wherein the delay of the delayed version of the most recently selected audio stream with respect to the current version of the most recently selected audio stream is adjustable, within the confines of the data maintained in the memory, based on user actuation of the delay control.

7. The apparatus of claim 6, wherein the memory is continuously updated so that data representing the most recent at least about three minutes of the first, second, and third audio streams is maintained in the memory.

8. The apparatus of claim 1, wherein the stream-select control comprises an actuator for selecting an audio stream by stepping through the audio streams in sequence.

9. The apparatus of claim 8, wherein the stream-select control comprises an additional actuator for selecting an audio stream by stepping through the audio streams in reverse sequence.

10. The apparatus of claim 9, wherein the delay of the delayed version of the most recently selected audio stream with respect to the current version of the most recently selected audio stream is adjustable, within the confines of the data maintained in the memory, based on user actuation of the delay control.

11. The apparatus of claim 10, wherein the memory is continuously updated so that data representing the most recent at least about three minutes of the first, second, and third audio streams is maintained in the memory.

12. The apparatus of claim 1, wherein the memory is continuously updated so that data representing the most recent at least about three minutes of the first, second, and third audio streams is maintained in the memory.

13. The apparatus of claim 1, wherein the at least one radio receiver comprises: a first radio receiver that receives a broadcast of a first audio stream; a second radio receiver that receives a broadcast of a second audio stream; and a third radio receiver that receives a broadcast of a third audio stream.

14. The apparatus of claim 1, wherein the at least one radio receiver comprises a single radio receiver that receives a multi-stream broadcast in which the first audio stream, the second audio stream, and the third audio stream are all encoded.

15. A method of presenting radio broadcasts to a user, the method comprising the steps of:
receiving, substantially simultaneously, radio broadcasts of a first audio stream, a second audio stream, and a third audio stream;
continuously updating the contents of a memory so that data representing the most recent at least twenty seconds of the first, second, and third audio streams is maintained in the memory;
providing a user interface that includes (a) a stream-select control that enables the user to select a desired audio stream and (b) a delay control that enables the user to request reproduction of a delayed version of whatever audio stream was most recently selected by the user;
outputting, in response to actuation of the stream-select control, a substantially current version of the audio stream selected by the user; and
outputting, in response to actuation of the delay control, a delayed version of the most recently selected audio stream based on the data in the memory representing the most recently selected audio stream.

16. The method of claim 15, wherein the stream-select control comprises a first button for selecting the first audio stream, a second button for selecting the second audio stream, and a third button for selecting the third audio stream.

17. The method of claim 16, wherein the delay of the delayed version of the most recently selected audio stream with respect to the current version of the most recently selected audio stream is adjustable, within the confines of the data maintained in the memory, based on user actuation of the delay control.

18. The method of claim 17, wherein the contents of the memory are continuously updated so that data representing the most recent at least about three minutes of the first, second, and third audio streams is maintained in the memory.

19. A buffered radio apparatus comprising:
a receiver having at least three presets;
a memory;
a control panel that includes a preset-select control and a delay control; and
a digital to audio subsystem,
wherein the receiver receives broadcasts for at least three presets substantially simultaneously,
wherein the memory is continuously refreshed so that the memory contains data representing the most recent at least twenty seconds of broadcast for each of the at least three presets,
wherein actuation of the preset-select control causes the apparatus to output a substantially current version of whatever preset is selected by the user, and
wherein actuation of the delay control causes the apparatus to output a delayed version of whatever preset was most recently selected by the user by routing data stored in the memory for the most recently selected preset to the digital to audio subsystem.

20. The apparatus of claim 19, wherein the preset-select control comprises a first button for selecting the first preset, a second button for selecting the second preset, and a third button for selecting the third preset.

21. The apparatus of claim 20, wherein the delay of the delayed version of the most recently selected preset with respect to the current version of the most recently selected preset is adjustable, within the confines of the data contained in the memory, based on user actuation of the delay control.

22. The apparatus of claim 21, wherein the memory is continuously refreshed so that the memory contains data representing the most recent at least about three minutes of broadcast for each of the at least three presets.
